(19) United States
(12) Patent Application Publication
(10) Pub. No.: US 2008/0223798 A1
(43) Pub. Date: Sep. 18, 2008

(54) Apparatus and System For Displacing Gas in a Biological Fluid Processing System

(75) Inventors: Jennifer Paretta, Wantagh, NY (US); Mladen Franovic, Stamford, CT (US)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, East Hills, NY (US)

(21) Appl. No.: 11/997,324

(22) PCT Filed: Jul. 21, 2006
(86) PCT No.: PCT/US06/28166

§ 371 Date: Jan. 30, 2008

Related U.S. Application Data
(60) Provisional application No. 60/705,488, filed on Aug. 5, 2005.

(51) Int. Cl. C02F 9/00; B01D 53/22

(52) U.S. Cl. 210/806; 210/257.1

(57) ABSTRACT

A biological fluid processing apparatus (50) including a biological fluid processing loop (75) for displacing air in a closed system while processing biological fluid, preferably, whole blood, is disclosed.

### CROSS REFERENCE TO RELATED APPLICATIONS

This patent application claims the benefit of U.S. Provisional Patent Application No. 60/705,488, filed Aug. 5, 2005, which is incorporated by reference.

### BACKGROUND OF THE INVENTION

This invention pertains to displacing gas in a biological fluid processing system.

A variety of blood processing systems are used for filtering blood and/or blood components, typically to deplete leukocytes from the blood and/or blood components. Some systems can also used for separating the blood into blood components before or after filtration. The filtered blood components can be stored in a container, typically, a plasticized bag, before use, e.g., as a transfusion product.

However, blood processing systems typically contain gas (air), and some air can be displaced into a receiving container of the processing system by the blood or blood component(s) passing through the elements of the system. The presence of a large volume of air in a container of blood or of a blood component is undesirable. Accordingly, some blood processing systems allow air to be vented to the atmosphere, or allow air to be passed to another container (via a bypass loop) in the blood processing system without venting the air to the atmosphere.

While systems that allow air to be vented to the atmosphere have been accepted for use in many countries, including the U.S., regulations in some countries prevent the use of such systems, due to concerns of possible bacterial contamination of the blood or blood components. However, while systems including bypass loops do not allow air to be vented to the atmosphere, the use of such systems can require a labor intensive effort (e.g., to compress the air-containing effluent bag to force the air through the bypass loop) and may be implicated in repetitive strain injuries by the technicians using the systems. Some technicians processing blood in systems with bypass loops do not utilize the bypass loops, in view of the effort required and fear of injury.

The present invention provides for ameliorating at least some of the disadvantages of the prior art. These and other advantages of the present invention will be apparent from the description as set forth below.

### BRIEF SUMMARY OF THE INVENTION

An embodiment of the invention provides an apparatus for processing gas and a biological fluid contained in a first container comprising at least two fluid ports comprising: a second container for containing a processed biological fluid; and a fluid processing loop comprising a biological fluid filter device comprising a biological fluid porous filter element and a biological fluid filter housing, the biological fluid porous filter element being disposed in the filter housing, and a vent comprising a vent element comprising a hydrophilic porous membrane, and a vent housing having a first inlet, a first outlet, and a second outlet, the vent housing defining a first fluid flow path between the first inlet and the first outlet, and defining a second fluid flow path between the first inlet and the second outlet, the vent housing containing the vent element, wherein the vent element is disposed between the first inlet and the second outlet across the second fluid flow path; wherein the fluid processing loop has first and second ends suitable for providing fluid communication with first and second fluid flow ports of the first container, and the fluid processing loop has a third end in fluid communication with a port of the second container for containing the processed biological fluid; wherein the fluid processing loop is arranged to allow gas to pass from the first container and along the second fluid flow path through the vent element and into the first container, without allowing biological fluid to pass through the vent into the first container, and to allow biological fluid to pass through the biological fluid filter and along the first fluid flow path into the second container, in a closed system.

In another embodiment, an apparatus for processing gas and a biological fluid contained in a first container comprising at least two fluid ports is provided comprising: a second container for containing a processed biological fluid; and a fluid processing loop comprising a biological fluid filter device comprising a biological fluid porous filter element and a biological fluid filter housing having a first inlet, a first outlet, and a second outlet, and defining a first fluid flow path between the first inlet and the first outlet, and defining a second fluid flow path between the first inlet and the second outlet, wherein the biological fluid porous filter element is disposed in the biological fluid filter housing across the first fluid flow path, the device further comprising a vent comprising a vent element comprising a hydrophilic porous membrane, the vent element being disposed in the biological fluid filter housing across the second fluid flow path; wherein the fluid processing loop has first and second ends suitable for providing fluid communication with first and second fluid flow ports of the first container, and the fluid processing loop has a third end in fluid communication with a port of the second container for containing the processed biological fluid; wherein the fluid processing loop is arranged to allow gas to pass from the first container and along the second fluid flow path through the vent element and into the first container, without allowing biological fluid to pass through the vent into the first container, and to allow biological fluid to pass through the biological fluid filter and along the first fluid flow path into the second container, in a closed system.

In some embodiments of the apparatus, the vent element comprises a hydrophilic porous membrane and a hydrophobic porous membrane.

Preferably, the apparatus is adapted to allow, after passing gas through the fluid processing loop into the first container, the passage of gas from the first container into the housing of the biological fluid filter device, e.g., to assist in draining the upstream portion of the biological fluid filter device.

In another embodiment of the invention, a biological fluid processing system is disclosed, wherein the system includes an embodiment of the apparatus, preferably, wherein the system includes a plurality of additional biological fluid containers and a plurality of additional conduits.

In yet another embodiment of the invention, a method for processing gas and biological fluid is disclosed, using an embodiment of the apparatus, more preferably, using an embodiment of the biological fluid processing system.

A method for processing biological fluid according to an embodiment of the invention comprises passing gas and a biological fluid from a first container having at least two fluid flow ports into a fluid processing loop comprising a biological fluid filter device comprising a biological fluid porous filter element and a housing having the biological fluid porous filter element disposed in the housing; and a vent comprising a vent element comprising a hydrophilic porous membrane, and a vent housing having a first inlet, a first outlet, and a second outlet, and defining a first fluid flow path between the first inlet and the first outlet, and a second fluid flow path between the first inlet and the second outlet, the vent housing containing the vent element disposed between the first inlet and the second outlet across the second fluid flow path; passing gas from the first container and along the second fluid flow path through the vent element and into the first container, without allowing biological fluid to pass through the vent into the first container; and passing biological fluid through the biological fluid filter and along the first fluid flow path into a second container; while maintaining a closed system.

A method for processing biological fluid according to another embodiment of the invention comprises passing gas and a biological fluid from a first container having at least two fluid flow ports into a fluid processing loop comprising a biological fluid filter device comprising a biological fluid porous filter element and a housing having a first inlet, a first outlet, and a second outlet, and defining a first fluid flow path between the first inlet and the first outlet, and defining a second fluid flow path between the first inlet and the second outlet, the biological fluid porous filter element being disposed in the housing across the first fluid flow path, the device further comprising a vent comprising a vent element comprising a hydrophilic porous membrane disposed in the housing across the second fluid flow path; passing gas from the first container and along the second fluid flow path through the vent element and into the first container, without allowing biological fluid to pass through the vent into the first container; and, passing biological fluid through the biological fluid filter and along the first fluid flow path into a second container; while maintaining a closed system. In some embodiments of the method, passing gas through the vent element comprises passing gas through a hydrophilic membrane and a hydrophobic membrane.

### BRIEF DESCRIPTION OF THE SEVERAL VIEWS OF THE DRAWING(S)

FIG. 1 is an embodiment of the present invention, comprising a biological fluid processing system comprising an apparatus for processing gas and biological fluid comprising a fluid processing loop comprising a biological fluid filter device comprising a biological fluid filter housing including a biological fluid porous filter element, and a vent comprising a vent housing and a vent element.

FIG. 2 is another embodiment of the present invention comprising a biological fluid processing system comprising an apparatus for processing gas and a biological fluid comprising a fluid processing loop comprising a biological fluid filter device comprising a biological fluid filter housing including a biological fluid porous filter element and a vent comprising vent element. FIG. 2A shows a partial cross-sectional view of the portion of the biological fluid filter housing including the vent element.

FIG. 3 shows various views of an embodiment of a biological fluid filter device including a vent. FIGS. 3A and 3B show external views of the filter device, FIG. 3B including a partial cross-sectional view of the portion of the filter housing including the vent. FIGS. 3C and 3D show elevated views of the inside surface of the outlet portion of the biological fluid filter housing. FIG. 3E shows a cross-sectional view of the biological fluid filter housing comprising a vent element and a vent element cover. FIGS. 3F-3H show top, bottom and cross-sectional views of the vent element cover. FIG. 3I shows an elevated view of the outside surface of the outlet portion of the biological fluid filter housing.

FIG. 4 is another embodiment of the present invention comprising a biological fluid processing system comprising an apparatus for processing gas and biological fluid comprising a fluid processing loop comprising a biological fluid filter device comprising a biological fluid filter housing including a biological fluid porous filter element and a vent comprising a vent element. FIG. 4A shows a cross-sectional view of the filter device including the vent element.

FIG. 5 is another embodiment of the present invention, comprising a biological fluid processing system comprising an apparatus for processing gas and biological fluid comprising fluid processing loop comprising a biological fluid filter device comprising a biological fluid filter housing including a biological fluid porous filter element, and a vent comprising a vent housing and a vent element.

### DETAILED DESCRIPTION OF THE INVENTION

In accordance with an advantage of the present invention, air can be processed (e.g., displaced) while processing a biological fluid in a closed biological fluid processing system, without interacting with atmospheric air. Another advantage is that the volume of air in the container of processed biological fluid (e.g., the effluent bag) can be reduced without requiring manipulation (e.g., compression) of the container. Yet another advantage is that air and biological fluid can be processed in a biological processing system with a less labor intensive effort compared to processing air and biological fluid in a biological processing system including a conventional bypass loop. Moreover, air can be channeled into the housing of the biological fluid filter device in the biological processing system to assist in draining the upstream portion of the housing, thus increasing the yield of recovered processed biological fluid.

In contrast with a typical ventless biological fluid processing system without a bypass loop (wherein, after filtration, typically about 50-70 ml of air is present in the bag containing the filtered biological fluid), biological fluid can be processed according to the invention wherein, after filtration, about 12-18 ml of air is present in the bag containing the filtered biological fluid.

In contrast with a conventional biological fluid processing system including a bypass loop, the presence of air in the bag containing the filtered biological fluid can be reduced without the labor intensive effort of compressing the bag to pass the air through the bypass loop.

An embodiment of the invention provides an apparatus for processing gas and a biological fluid contained in a first container comprising at least two fluid ports comprising: a second container for containing a processed biological fluid; and a fluid processing loop comprising a biological fluid filter device comprising a biological fluid porous filter element and a biological fluid filter housing, the biological fluid porous filter element being disposed in the filter housing, and a vent comprising a vent element comprising a hydrophilic porous membrane, and a vent housing having a first inlet, a first outlet, and a second outlet, the vent housing defining a first fluid flow path between the first inlet and the first outlet, and defining a second fluid flow path between the first inlet and the second outlet, the vent housing containing the vent element, wherein the vent element is disposed between the first inlet and the second outlet across the second fluid flow path; wherein the fluid processing loop has first and second ends suitable for providing fluid communication with first and second fluid flow ports of the first container, and the fluid processing loop has a third end in fluid communication with a port of the second container for containing the processed biological fluid; wherein the fluid processing loop is arranged to allow gas to pass from the first container and along the second fluid flow path through the vent element and into the first container, without allowing biological fluid to pass through the vent into the first container, and to allow biological fluid to pass through the biological fluid filter and along the first fluid flow path into the second container, in a closed system. In one embodiment, the vent element comprises a hydrophilic porous membrane and a hydrophobic porous membrane.

In another embodiment, an apparatus for processing gas and a biological fluid contained in a first container comprising at least two fluid ports is provided comprising: a second container for containing a processed biological fluid; and a fluid processing loop comprising a biological fluid filter device comprising a biological fluid porous filter element and a biological fluid filter housing having a first inlet, a first outlet, and a second outlet, and defining a first fluid flow path between the first inlet and the first outlet, and defining a second fluid flow path between the first inlet and the second outlet, wherein the biological fluid porous filter element is disposed in the biological fluid filter housing across the first fluid flow path, the device further comprising a vent comprising a vent element comprising a hydrophilic porous membrane, the vent element being disposed in the biological fluid filter housing across the second fluid flow path; wherein the fluid processing loop has first and second ends suitable for providing fluid communication with first and second fluid flow ports of the first container, and the fluid processing loop has a third end in fluid communication with a port of the second container for containing the processed biological fluid; wherein the fluid processing loop is arranged to allow gas to pass from the first container and along the second fluid flow path through the vent element and into the first container, without allowing biological fluid to pass through the vent into the first container, and to allow biological fluid to pass through the biological fluid filter and along the first fluid flow path into the second container, in a closed system.

In some embodiments of the apparatus, the vent element comprises a hydrophilic porous membrane and a hydrophobic porous membrane.

Preferably, the apparatus is arranged to allow, after passing gas through the fluid processing loop into the first container, the passage of gas from the first container into the housing of the biological fluid filter device, e.g., to assist in draining the upstream portion of the biological fluid filter device.

In another embodiment of the invention, a biological fluid processing system is disclosed, wherein the system includes an embodiment of the apparatus, preferably, wherein the system includes a plurality of additional biological fluid containers and a plurality of additional conduits.

In yet another embodiment of the invention, a method for processing gas and biological fluid is disclosed, using an embodiment of the apparatus, more preferably, using an embodiment of the biological fluid processing system.

A method for processing biological fluid according to an embodiment of the invention comprises passing gas and a biological fluid from a first container having at least two fluid flow ports into a fluid processing loop comprising a biological fluid filter device comprising a biological fluid porous filter element and a housing having the biological fluid porous filter element disposed in the housing; and a vent comprising a vent element comprising a hydrophilic porous membrane, and a vent housing having a first inlet, a first outlet, and a second outlet, and defining a first fluid flow path between the first inlet and the first outlet, and a second fluid flow path between the first inlet and the second outlet, the vent housing containing the vent element disposed between the first inlet and the second outlet across the second fluid flow path; passing gas from the first container and along the second fluid flow path through the vent element and into the first container, without allowing biological fluid to pass through the vent into the first container; and passing biological fluid through the biological fluid filter and along the first fluid flow path into a second container; while maintaining a closed system.

A method for processing biological fluid according to another embodiment of the invention comprises passing gas and a biological fluid from a first container having at least two fluid flow ports into a fluid processing loop comprising a biological fluid filter device comprising a biological fluid porous filter element and a housing having a first inlet, a first outlet, and a second outlet, and defining a first fluid flow path between the first inlet and the first outlet, and defining a second fluid flow path between the first inlet and the second outlet, the biological fluid porous filter element being disposed in the housing across the first fluid flow path, the device further comprising a vent comprising a vent element comprising a hydrophilic porous membrane disposed in the housing across the second fluid flow path; passing gas from the first container and along the second fluid flow path through the vent element and into the first container, without allowing biological fluid to pass through the vent into the first container; and, passing biological fluid through the biological fluid filter and along the first fluid flow path into a second container; while maintaining a closed system.

In some embodiments of the method, passing gas through the vent element comprises passing gas through a hydrophilic membrane and a hydrophobic membrane.

In one embodiment, the method further comprises, after passing gas into the first container, passing gas from the first container into the biological fluid filter housing, e.g., to drain the portion of the housing upstream of the biological fluid porous filter element.

Each of the components of the invention will now be described in more detail below, wherein like components have like reference numbers.

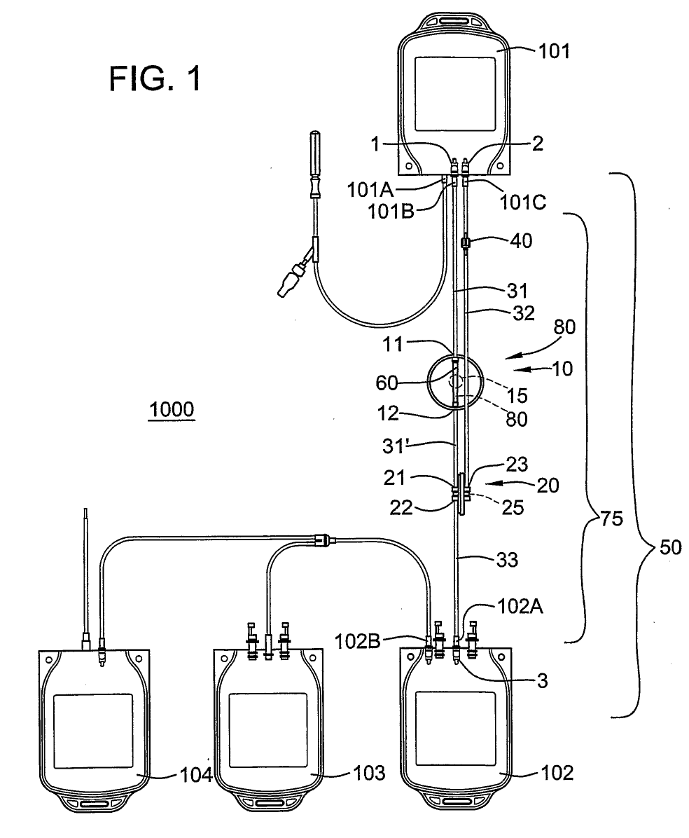

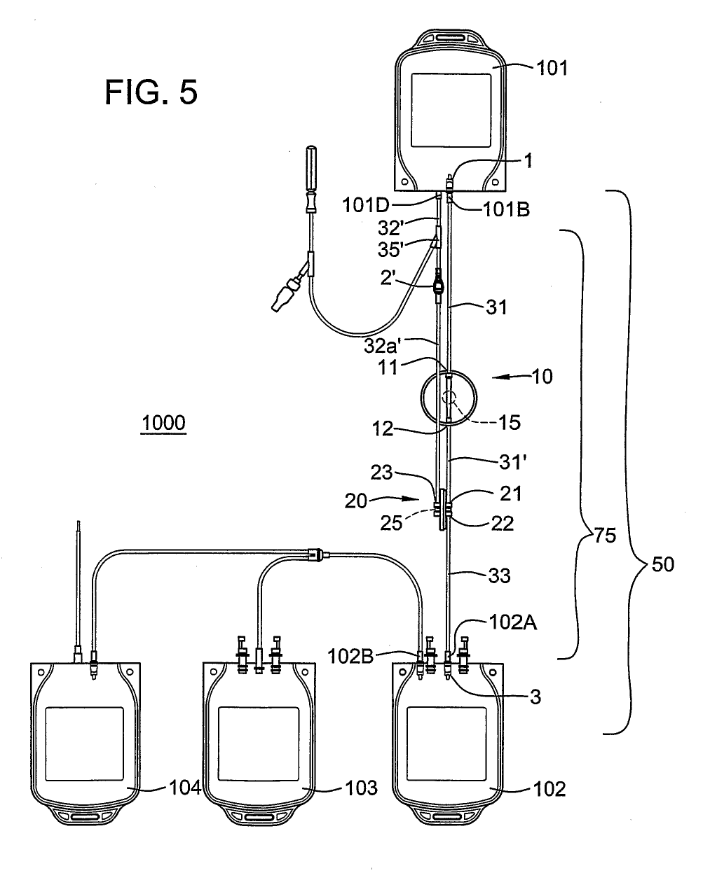

FIGS. 1, 2, 4, and 5 show embodiments of a biological fluid processing system 1000 including an apparatus 50 for processing gas and a biological fluid contained in a first container 101 (comprising a source and/or collection container) having a plurality of fluid flow ports. The containers utilized in accordance with the invention can have any suitable number of fluid flow ports. In the embodiments of the system 1000 illustrated in FIGS. 1, 2, and 4, first container 101 includes at least three fluid flow ports 101A, 101B, and 101C, and in the embodiment of the system 1000 illustrated in FIG. 5, the first container 101 includes at least two fluid flow ports 101B and 101D.

In the illustrated embodiments, apparatus 50 comprises a second container 102 for containing a processed biological fluid, the second container comprising at least two fluid flow ports, and a fluid processing loop 75 comprising a plurality of conduits, a biological fluid filter device 10, 10′, and a vent comprising a vent element 25.

In the embodiments illustrated in FIGS. 1, 2, and 4, the fluid processing loop 75 comprises first conduit 31 (wherein one end of conduit 31 is illustrated as fluid tightly attached to first container fluid flow port 101B), second conduit 32 (wherein one end of conduit 32 is illustrated as fluid tightly attached to first container fluid flow port 101C), and third conduit 33 (wherein one end of conduit 33 is illustrated as fluid tightly attached to second container fluid flow port 102A). In the embodiment illustrated in FIG. 1, the fluid processing loop 75 further comprises fourth conduit 31′, wherein the ends of the conduit 31′ are illustrated as fluid tightly attached to the outlet of a biological fluid filter 10 and the first inlet of a vent as described in more detail below.

In the embodiment illustrated in FIG. 5, the fluid processing loop 75 comprises first conduit 31 (wherein one end of conduit 31 is illustrated as fluid tightly attached to first container fluid flow port 101B), second conduit 32′ (wherein one end of conduit 32′ is illustrated as fluid tightly attached to first container fluid flow port 101D), and third conduit 33 (wherein one end of conduit 33 is illustrated as fluid tightly attached to second container fluid flow port 102A). In the embodiment illustrated in FIG. 5, the fluid processing loop 75 further comprises a connector 35′, fourth conduit 31′, and fifth conduit 32a′, wherein the connector is illustrated as fluid tightly connected to the other end of second conduit 32′ and to one end of fifth conduit 32a′, and the ends of fourth conduit 31′ are illustrated as fluid tightly attached to the outlet of a biological fluid filter 10 and the first inlet of a vent as described in more detail below.

In accordance with the illustrated embodiments of the apparatus 50, the fluid processing loop 75 further comprises a biological fluid filter device 10, 10′ comprising a biological fluid porous filter element 15 and a biological fluid filter housing comprising an inlet section having an inlet and an outlet section having an outlet and defining a fluid flow path between the inlet and the outlet, wherein the biological fluid porous filter element 15 is in the housing, across the fluid flow path. In some embodiments, and as described in more detail below, the biological fluid filter housing further comprises an additional outlet and defines an additional fluid flow path between the inlet and the additional outlet.

In accordance with the embodiment of the apparatus 50 illustrated in FIG. 1, the fluid processing loop 75 comprises a biological fluid filter device 10 comprising a biological fluid porous filter element 15 and a biological fluid filter housing comprising an inlet section 80 having an inlet 11 (illustrated as fluid tightly attached to an end of conduit 31) and an outlet section 60 having an outlet 12 (illustrated as fluid tightly attached to an end of conduit 31′) and defining a fluid flow path between the inlet and the outlet, wherein the biological fluid porous filter element 15 is in the housing, across the fluid flow path, and the loop also comprises a vent 20 comprising a vent element 25 comprising a hydrophilic porous membrane (in some embodiments, the vent element 25 comprises a hydrophilic porous membrane and a hydrophobic porous membrane) and a vent housing having a first inlet 21 (illustrated as fluid tightly attached to the other end of conduit 31′), a first outlet 22 (illustrated as fluid tightly attached to an end of conduit 33), and a second outlet 23 (illustrated as fluid tightly attached to an end of conduit 32), the vent defining a first fluid flow path between the first inlet 21 and the first outlet 22, and defining a second fluid flow path between the first inlet 21 and the second outlet 23, the vent housing containing the vent element 25 disposed between the first inlet 21 and the second outlet 23 across the second fluid flow path, wherein the fluid processing loop 75 has first and second ends suitable for providing fluid communication with first and second fluid flow ports 101B and 101C of the first container 101, and the fluid processing loop has a third end in fluid communication with a port 102A of the second container 102 for containing a processed biological fluid; wherein the fluid processing loop 75 is arranged to allow gas to pass from a port of the first container 101 and along the second fluid flow path through the vent element 25 and into another port the first container 101, without allowing biological fluid to pass through the vent 20 into the first container 101, and to allow biological fluid to pass through the biological fluid filter device 10 and along the first fluid flow path into the second container 102, in a closed system.

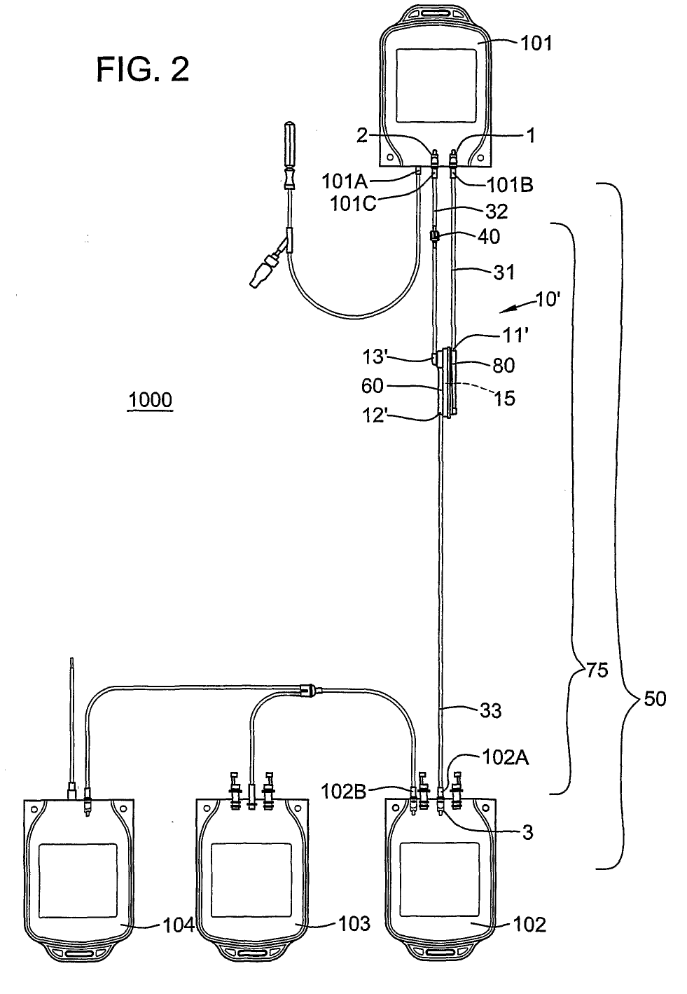

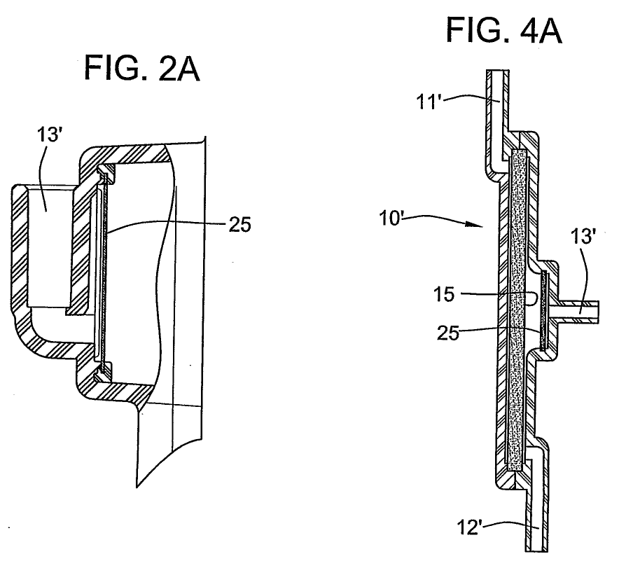

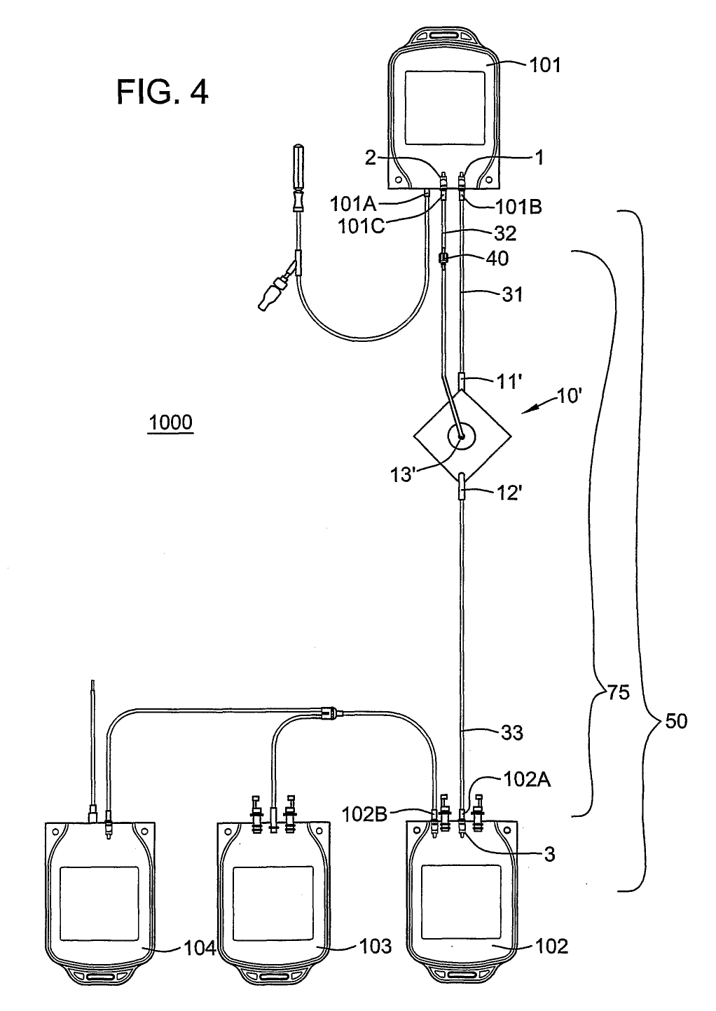

In accordance with the embodiment of the apparatus 50 illustrated in FIGS. 2 and 4, the fluid processing loop 75 comprises a biological fluid filter device 10′ comprising a biological fluid porous filter element 15 and a biological fluid filter housing comprising an inlet section 80 having a first inlet 11′ (illustrated as fluid tightly attached to an end of conduit 31), and an outlet section 60 comprising a first outlet 12′ (illustrated as fluid tightly attached to an end of conduit 33), and a second outlet 13′ (illustrated as fluid tightly attached to an end of conduit 32) and defining a first fluid flow path between the first inlet 11′ and the first outlet 12′, and defining a second fluid flow path between the first inlet 11′ and the second outlet 13′, wherein the biological fluid porous filter element 15 is in the housing across the first fluid flow path, the device 10′ further comprising a vent comprising a vent element 25 comprising a hydrophilic porous membrane (in some embodiments the vent element 25 comprises a hydrophilic porous membrane and a hydrophobic porous membrane) in the biological fluid filter housing across the second fluid flow path, wherein the fluid processing loop 75 has first and second ends suitable for providing fluid communication with first and second fluid flow ports 101B and 101C of the first container 101, and the fluid processing loop 75 has a third end in fluid communication with a port 102A of the second container 102 for containing a processed biological fluid; wherein the fluid processing loop 75 is arranged to allow gas to pass from a port of the first container 101 and along the second fluid flow path through the vent element 25 and into another port of the first container 101, without allowing biological fluid to pass through the vent into the first container, and to allow biological fluid to pass through the biological fluid filter 10′ and along the first fluid flow path into the second container 102, in a closed system.

In accordance with the embodiment of the apparatus 50 illustrated in FIG. 5, the fluid processing loop 75 comprises a biological fluid filter device 10 comprising a biological fluid porous filter element 15 and a biological fluid filter housing comprising an inlet section 80 having an inlet 11 (illustrated as fluid tightly attached to an end of conduit 31) and an outlet section 60 having an outlet 12 (illustrated as fluid tightly attached to an end of conduit 31′) and defining a fluid flow path between the inlet and the outlet, the biological fluid porous filter element 15 disposed in the housing, across the fluid flow path, the loop further comprising a vent 20 comprising a vent element 25 comprising a hydrophilic porous membrane (in some embodiments, the vent element 25 comprises a hydrophilic porous membrane and a hydrophobic porous membrane) and a vent housing having a first inlet 21 (illustrated as fluid tightly attached to the other end of conduit 31′), a first outlet 22 (illustrated as fluid tightly attached to an end of conduit 33), and a second outlet 23 (illustrated as fluid tightly attached to an end of conduit 32a′), the vent defining a first fluid flow path between the first inlet 21 and the first outlet 22, and defining a second fluid flow path between the first inlet 21 and the second outlet 23, the vent housing containing the vent element 25 between the first inlet 21 and the second outlet 23 and across the second fluid flow path, wherein the fluid processing loop 75 has first and second ends suitable for providing fluid communication with first and second fluid flow ports 101B and 101D of the first container 101, and the fluid processing loop has a third end in fluid communication with a port 102A of the second container 102 for containing a processed biological fluid; wherein the fluid processing loop 75 is arranged to allow gas to pass from a port of the first container 101 and along the second fluid flow path through the vent element 25 and into another port the first container 101, without allowing biological fluid to pass through the vent 20 into the first container 101, and to allow biological fluid to pass through the biological fluid filter 10 and along the first fluid flow path into the second container 102, in a closed system.

The biological fluid processing system 1000 includes a plurality of conduits and containers. A variety of conduits and containers, e.g., plasticized tubing and bags, are suitable for use in the invention, and are known in the art. In the illustrated embodiments, the system 1000 includes the first container 101, the second container 102 (as the illustrated system comprises apparatus 50, comprising second container 102), a third container 103, and a fourth container 104. As noted above, the containers can have any suitable number of fluid flow ports.

The biological fluid processing system typically includes a plurality of flow control devices such as valves, clamps, and/or transfer leg closures (sometimes referred to as breakaway valves). A variety of flow control devices are suitable for use in the invention, and are known in the art. In the embodiments illustrated in FIGS. 1, 2, 4 and 5, the system 1000 includes at least three transfer leg closures. FIGS. 1, 2, and 4 illustrate three transfer leg closures, 1, 2, and 3. FIG. 5 illustrates three transfer leg closures, 1, 2′, and 3. In some embodiments of the invention, the apparatus 50 includes one or more of the transfer leg closures. However, the inclusion of transfer leg closures is optional, in other embodiments of the invention, the apparatus 50 and/or the system 1000 does not include a transfer leg closure.

The illustrated embodiments shown in FIGS. 1, 2, and 4 also show an optional check valve 40 in the conduit 32 communicating with port 101C and second outlet 23 (FIG. 1) or 13′ (FIGS. 2 and 4). A variety of check valves are suitable for use in the invention and are known in the art. The check valve preferably comprises a normally closed one-way valve that allows unidirectional fluid flow, i.e., allowing forward flow and preventing backflow. Typically, a normally closed one-way valve comprises an elastomeric material providing a sealing element that, upon applied stress (e.g., pressure), opens and allows forward flow, and, upon the release of the stress, returns or rebounds to the original closed position. Exemplary one-way valves comprising elastomeric material include duckbill valves, e.g., including elastomeric lips in the shape of a duckbill; diaphragm valves, e.g., a diaphragm including slits providing two or more elastomeric flaps; and umbrella valves, e.g., including an elastomeric diaphragm-shaped sealing disk or umbrella shape, typically wherein the sealing disk has a preloaded convex shape to create the sealing force against the port, or valve seat.

In other embodiments (not shown), a check valve is not present and/or a clamp or transfer leg closure can be utilized instead of a check valve.

Apparatus 50 can include additional elements such as one or more conduits, containers and/or flow control devices. In one preferred embodiment, apparatus 50 further comprises the first container 101.

The biological fluid filter device 10, 10′ can have a variety of housing configurations. In some embodiments, the biological fluid filter housing includes a vent. The housing can include a variety of configurations for arranging and/or sealing the vent element in the housing. Alternatively, or additionally, the vent element can be disposed at a variety of locations in or on the housing, e.g., located toward the upper (during filtration) part of the housing (for example, in the upper part of the outlet portion of housing as shown in FIG. 2) or located or located toward another part of the housing (for example in the middle part of the outlet portion of the housing as shown in FIG. 4).

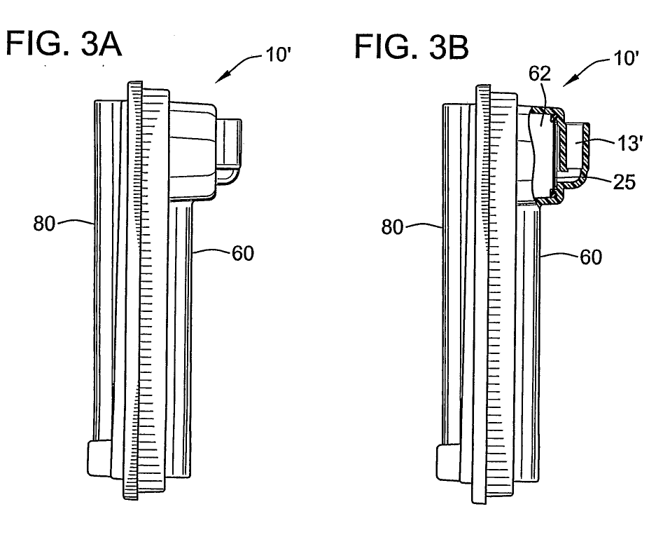

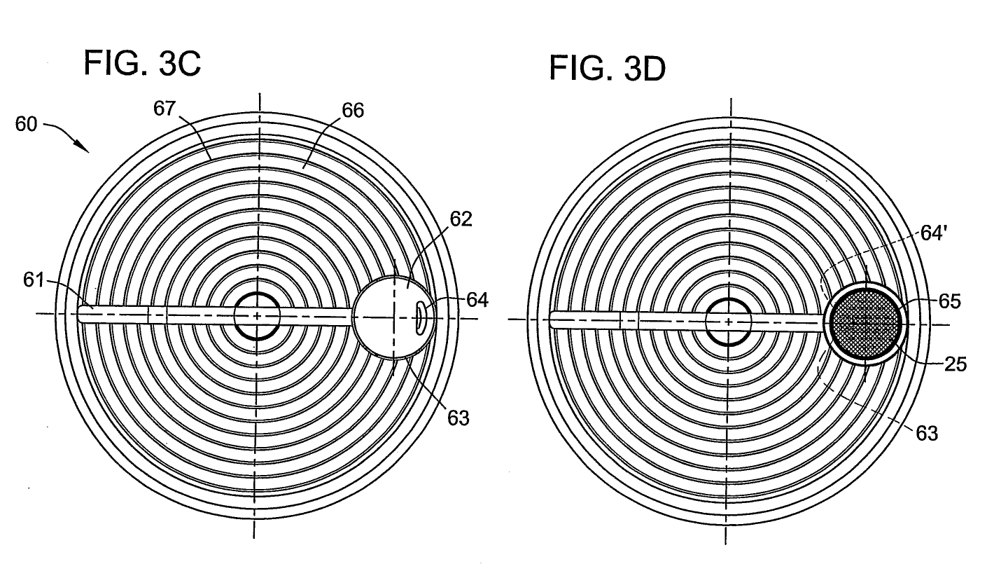

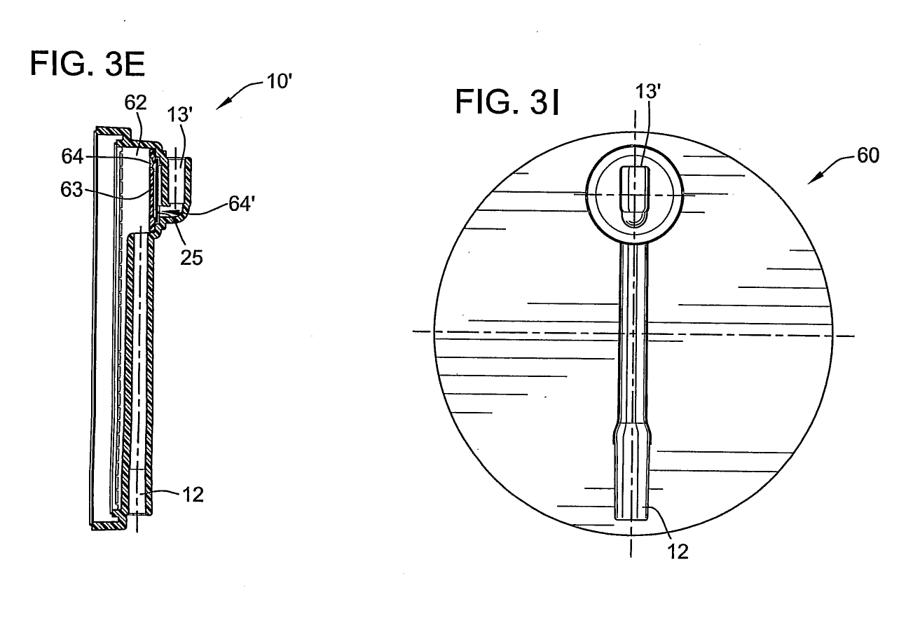

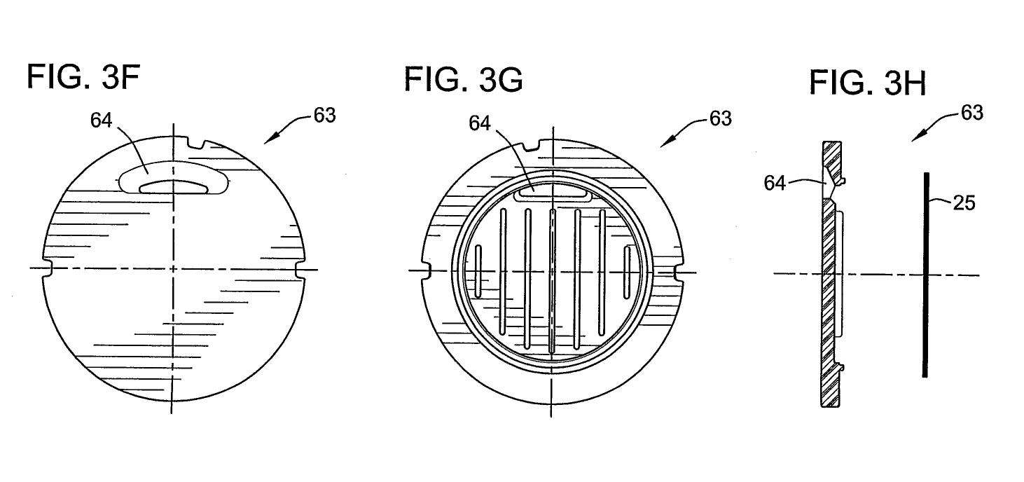

FIGS. 3 and 4 shows various views of illustrative embodiments of biological fluid filter housings including a vent, and FIG. 3 particularly shows views of portions of an embodiment of the biological fluid outlet section of the housing, e.g., showing portions of the housing downstream of the biological fluid porous filter element 15.

As will be explained in more detail below, in some embodiments, including some embodiments wherein the biological fluid filter includes the vent, as biological fluid passes through the biological fluid filter element 15, air is displaced and flows toward the upper part of the housing, and air passes ahead of the rising biological fluid level in the outlet section of the housing so that the air can be more efficiently cleared from the housing and through the vent ahead of the flow of the biological fluid. However, in other embodiments, e.g., as illustrated in FIGS. 4 and 4A, the vent is not located near the upper part of the housing, and as biological fluid passes through the biological fluid filter element 15, air is displaced and is efficiently cleared from the housing through the vent.

FIGS. 3A and 3B show sideways external views of an embodiment of the biological fluid filter housing having an inlet section 80 and an outlet section 60, wherein FIG. 3B shows a partial cross-sectional view of the portion of the outlet section of the filter housing including the vent and vent chamber. FIG. 3G shows a rear external view of the outlet section 60.

FIGS. 3C and 3D shows an elevated internal view of an outlet section 60 including the vent chamber. FIGS. 3B-3E show one arrangement for sealing the vent element 25 in the housing. FIG. 3C shows an elevated view of the inside surface of the outlet section 60 with a slot 61 communicating with a receiving zone 62 communicating with vent element 25 (shown in FIGS. 3B, and 3D). In those embodiments including the slot 61, air separates from the liquid biological fluid in the slot and rises to toward the outlet 13′ and can be almost completely vented before the biological fluid contacts the vent element 25.

FIGS. 3C-3E also show zone 62 has a wall formed by cover 63, the cover having a port 64, wherein the cover 63 can be sealed against vent wall 65. Vent wall 65 has a port 64′. As shown in the various views in FIG. 3C-3H, a vent chamber is formed when vent element 25 is sealed between cover 63 and vent wall 65. Accordingly, and using FIGS. 3C-3E for reference, gas passes along slot 61 into zone 62, through port 64, the hydrophilic membrane of the vent element 25 (in those embodiments wherein the vent element 25 comprises a hydrophilic membrane and a hydrophobic membrane, the gas passes through port 64 and through the hydrophilic and the hydrophobic media of the vent element 25), port 64′, and through outlet 13, and gas flow continues until the biological fluid sufficiently contacts the hydrophilic medium of the vent element.

In the embodiment illustrated in FIGS. 3C and 3D, the surfaces of the cover 63 and vent wall 65 facing the surfaces of the vent element 25 each include a plurality of ribs and channels, e.g., to improve the efficiency of gas flow, e.g., wherein the ribs provide for supporting or positioning the vent element 25 within the vent chamber while providing clearance between portions of the surfaces of the cover and vent wall and portions of the surfaces of the vent element 25.

In the embodiment illustrated in FIG. 3C, the inside surface of the outlet section 60 of the housing also includes a plurality of concentric circular grooves 66 and concentric circular ridges 67, wherein the ridges define the grooves. The ridges abut the downstream surface of the biological fluid filter element. In those embodiments including the circular grooves and ridges, the grooves collect the filtered biological fluid, and the slot 61 collects the fluid from each groove. Additionally, as noted above, air separates from the biological fluid in the slot, and passes ahead of the biological fluid and through the vent element.

As noted above, in those embodiments wherein the biological fluid filter device filter housing includes a vent, the housing can include a variety of configurations for arranging and/or sealing the vent element in the housing. Accordingly, for example, in some embodiments, the device does not include a cover for the vent element and/or the device does not include ribs and/or channels facing either or both surfaces of the vent element.

In one illustrative embodiment of a method for processing gas and biological fluid according to the invention, and using FIG. 1 for reference, first container 101 contains a unit of biological fluid (passed into the container through port 101A), and transfer leg closures 1, 2, and 3 are initially closed. In those embodiments also including a valve 40 such as a check valve in the conduit 32 communicating with port 101C and transfer leg closure 2, the check valve is closed also (e.g., the check valve is a normally closed valve). Typically, the conduit leading from the phlebotomy needle to port 101A is clamped and/or heat sealed. While transfer leg closure 3 remains closed, transfer leg closure 1 is opened first, and transfer leg closure 2 is opened next. Biological fluid (preferably, a red blood cell containing fluid, e.g., whole blood) is passed from port 101B of the first container 101 through the end of the conduit 31 communicating with transfer leg closure 1 through port 101B. The biological fluid displaces gas through the conduit, and the gas (followed by the biological fluid) passes from the other end of the conduit 31 into the biological fluid filter device 10 through the biological fluid housing inlet 11, the biological fluid porous filter element 15 (preferably a leukocyte depletion medium), the biological fluid housing outlet 12, and through conduit 31′ into the first inlet 21 of the vent housing. Gas passes along the second fluid flow path from the first inlet 21 through the vent element 25, passing through the hydrophilic membrane (in those embodiments wherein the vent element 25 comprises a hydrophilic porous membrane and a hydrophobic porous membrane, the gas passes through the hydrophilic membrane and then the hydrophobic membrane) and through the second outlet 23 and into the first container 101 through conduit 32 and port 101C.

In those embodiments including a check valve 40, gas passes through the valve (that allows one-way flow) in conduit 32 into the first container. The filtered (e.g., leukocyte-depleted) biological fluid passes through the first inlet 21 and contacts the hydrophilic medium. The biological fluid does not pass through the vent element 25 into the first container. Once the biological fluid sufficiently contacts (e.g., wets) the hydrophilic medium, the vent element 25 seals so that gas does not pass through. If the vent housing is transparent or partially transparent, the operator will typically be able to see that the biological fluid has contacted the vent element. Moreover, the operator will typically see that gas has stopped passing through the conduit 32 and port 101C into the first container 101 (e.g., the operator will see that air bubbles have stopped passing through the port into the bag). Transfer leg closure 3 is then opened, and filtered biological fluid passes through the first outlet 22 and conduit 33 into the second container 102 through port 102A. In some embodiments, after transfer leg closure 3 is opened, and after the first container 101 is essentially drained of biological fluid, gas passes from the first container and port 101B through the conduit 31 and through the biological fluid filter housing inlet 21 into the upstream portion of the biological fluid filter housing, thus allowing more efficient drainage of the biological fluid from the upstream portion of the housing.

In another illustrative embodiment of a method for processing gas and biological fluid according to the invention, and using FIGS. 2 and 4 for reference, first container 101 contains a unit of biological fluid (passed into the container through port 101A), and transfer leg closures 1, 2, and 3 are initially closed. In those embodiments also including a valve 40 such as a check valve in the conduit 32 communicating with port 101C and transfer leg closure 2, the check valve is closed also (e.g., the check valve is a normally closed valve). Typically, the conduit leading from the phlebotomy needle to port 101A is clamped and/or heat sealed. While transfer leg closure 3 remains closed, transfer leg closure 1 is opened first, and transfer leg closure 2 is opened next. Biological fluid (preferably, a red blood cell containing fluid, e.g., whole blood) is passed from port 101B of the first container 101 through the end of conduit 31 communicating with transfer leg closure 1 through port 101B. The biological fluid displaces gas through the conduit, and the gas (followed by the biological fluid) passes into the biological fluid filter device 10′ through the first inlet 11′ of the biological fluid housing, and through the biological fluid porous filter element 15 (preferably a leukocyte depletion medium). Now using FIGS. 2, 3E, 4, and 4A for reference, gas passes along the second fluid flow path through the vent element 25 (with respect to the embodiment illustrated in FIG. 3E—passing through the port 64, the hydrophilic membrane and then the hydrophobic membrane (if present) of vent element 25, and port 64′; with respect to the embodiment illustrated in FIG. 4A—passing through the hydrophilic membrane and then the hydrophobic membrane (if present) of vent element 25) through the second outlet 13′ of the biological fluid filter housing and through conduit 32 into the first container 101 through port 101C.

In those embodiments including a check valve 40, gas passes through the valve (that allows one-way flow) in conduit 32 into the first container. The filtered (e.g., leukocyte-depleted) biological fluid passes through the biological fluid porous filter element 15 and contacts the hydrophilic medium of the vent element. The biological fluid does not pass through the vent element 25 into the first container. Once the biological fluid sufficiently contacts (e.g., wets) the hydrophilic medium, the vent element 25 seals so that gas does not pass through. If the biological fluid filter housing is transparent or partially transparent, the operator will typically be able to see that the biological fluid has contacted the vent element. Moreover, the operator will typically see that gas has stopped passing through the conduit 32 into the first container 101 through port 101C (e.g., the operator will see that air bubbles have stopped passing through the port into the bag). Transfer leg closure 3 is then opened, and filtered biological fluid passes through the first outlet 12′ and conduit 33 into the second container 102 through port 102A. In some embodiments, after transfer leg closure 3 is opened, and after the first container 101 is essentially drained of biological fluid, gas passes from the first container through port 101B and conduit 31 and through the biological fluid filter housing first inlet 11′ into the upstream portion of the biological fluid filter housing, thus allowing more efficient drainage of the biological fluid from the upstream portion of the housing.

In another illustrative embodiment of a method for processing gas and biological fluid according to the invention, and using FIG. 5 for reference, first container 101 contains a unit of biological fluid (passed into the container through connector 35′ and conduit 32′ through port 101D), and transfer leg closures 1, 2′, and 3 are initially closed. Typically, the conduit leading from the phlebotomy needle to connector 35′ is clamped and/or heat sealed. While transfer leg closure 3 remains closed, transfer leg closure 1 is opened first, and transfer leg closure 2′ is opened next. Biological fluid (preferably, a red blood cell containing fluid, e.g., whole blood) is passed from port 101B of the first container 101 through the end of the conduit 31 communicating with transfer leg closure 1 through port 101B. The biological fluid displaces gas through the conduit, and the gas (followed by the biological fluid) passes from the other end of the conduit 31 into the biological fluid filter device 10 through the biological fluid housing inlet 11, the biological fluid porous filter element 15 (preferably a leukocyte depletion medium), the biological fluid housing outlet 12, and through conduit 31′ into the first inlet 21 of the vent housing. Gas passes along the second fluid flow path from the first inlet 21 through the vent element 25, passing through the hydrophilic membrane (in those embodiments wherein the vent element 25 comprises a hydrophilic porous membrane and a hydrophobic porous membrane, the gas passes through the hydrophilic membrane and then the hydrophobic membrane) and through the second outlet 23 and into the first container 101 through the second outlet 23 and into the first container 101 through conduit 32a′, connector 35, conduit 32′ and port 101D. The filtered (e.g., leukocyte-depleted) biological fluid passes through the first inlet 21 and contacts the hydrophilic medium. The biological fluid does not pass through the vent element 25 into the first container. Once the biological fluid sufficiently contacts (e.g., wets) the hydrophilic medium, the vent element 25 seals so that gas does not pass through. If the vent housing is transparent or partially transparent, the operator will typically be able to see that the biological fluid has contacted the vent element. Moreover, the operator will typically see that gas has stopped passing through the conduit 32′ and port 101D into the first container 101 (e.g., the operator will see that air bubbles have stopped passing through the port into the bag). Transfer leg closure 3 is then opened, and filtered biological fluid passes through the first outlet 22 and conduit 33 into the second container 102 through port 102A. In some embodiments, after transfer leg closure 3 is opened, and after the first container 101 is essentially drained of biological fluid, gas passes from the first container and port 101B through the conduit 31 and through the biological fluid filter housing inlet 21 into the upstream portion of the biological fluid filter housing, thus allowing more efficient drainage of the biological fluid from the upstream portion of the housing.

With reference to FIG. 5, it should be noted that connector 35′ and conduit 32′ will remain filled with blood after collection is completed, and the conduit between the needle and connector 35′ is sealed off. Because the liquid column in conduit 32′ and the body of connector 35′ will tend to act as an unbalancing force with respect to the desired direction of subsequent gas flow, both the length of conduit 32′ and length of connector 35′ should be as short as practical. However, in general, a length of conduit 31, 31′ and 32a′ can be found to compensate for virtually any length of column in 32′ and 35′, by adjusting the lengths of 31, 31′ and 32a′ so that, after transfer leg closure 1 is operated, the compliance of the air column in these lengths of conduits allows the incoming blood to compress this air column to a level lower than that present in conduit 32′ and connector 35′. This assures that after the operation of transfer leg closure 2′, the blood will flow down conduit 31, and air will be displaced from filter device 10, conduit 31′, into vent 20 and into container 101.

In typical embodiments of a method according to the invention, the biological fluid in second container 102 is further processed, e.g., to separate the biological fluid into components and/or to combine the biological fluid/fluid components with one or more additive and/or storage solutions.

For example, the biological fluid in second container 102 can be centrifuged to provide 2 layers (e.g., a supernatant layer comprising platelet-rich-plasma (PRP) and a sediment layer comprising packed red blood cells), or 3 layers (e.g., a supernatant layer comprising platelet-poor-plasma (PPP), an intermediate layer comprising buffy coat, and a sediment layer comprising packed red blood cells). If desired, any number of layers can be expressed from the container (e.g., into containers 103 and/or 104) to be further processed. In some embodiments, an additive and/or storage solution can be added to container 102, or any other container. For example, in some embodiments wherein the packed red blood cells remain in container 102 after expressing the other layer(s) from the container, a red blood cell additive and/or storage solution can be added to the container, and mixed with the red blood cells.

The following definitions are used in accordance with the invention:

Biological Fluid. A biological fluid includes any treated or untreated fluid associated with living organisms, particularly blood, including whole blood, warm or cold blood, and stored or fresh blood; treated blood, such as blood diluted with at least one physiological solution, including but not limited to saline, nutrient, and/or anticoagulant solutions; blood components, such as platelet concentrate (PC), platelet-rich plasma (PRP), platelet-poor plasma (PPP), platelet-free plasma, plasma, fresh frozen plasma (FFP), components obtained from plasma, packed red cells (PRC), transition zone material or buffy coat (BC); blood products derived from blood or a blood component or derived from bone marrow; stem cells; red cells separated from plasma and resuspended in physiological fluid or a cryoprotective fluid; and platelets separated from plasma and resuspended in physiological fluid or a cryoprotective fluid. The biological fluid may have been treated to remove some of the leukocytes before being processed according to the invention. As used herein, blood product or biological fluid refers to the components described above, and to similar blood products or biological fluids obtained by other means and with similar properties.

A “unit” is the quantity of biological fluid from a donor or derived from one unit of whole blood. It may also refer to the quantity drawn during a single donation. Typically, the volume of a unit varies, the amount differing from patient to patient and from donation to donation. Multiple units of some blood components, particularly platelets and buffy coat, may be pooled or combined, typically by combining four or more units.

As used herein, the term “closed” refers to a system that allows the collection and processing (and, if desired, the manipulation, e.g., separation of portions, separation into components, filtration, storage, and preservation) of biological fluid, e.g., donor blood, blood samples, and/or blood components, without the need to compromise the sterile integrity of the system. A closed system can be as originally made, or result from the connection of system components using what are known as “sterile docking” devices. Illustrative sterile docking devices are disclosed in U.S. Pat. Nos. 4,507,119, 4,737,214, and 4,913,756. In preferred embodiments of the invention, the biological fluid processing system includes the apparatus and further comprises the first container, and is closed as originally made.

A filter element 15 can have any suitable pore structure, e.g., a pore size (for example, as evidenced by bubble point, or by KL as described in, for example, U.S. Pat. No. 4,340,479), a pore rating, a pore diameter (e.g., when characterized using the modified OSU F2 test as described in, for example, U.S. Pat. No. 4,925,572), that reduces or allows the passage therethrough of one or more materials of interest as the fluid is passed through the element. In accordance with the invention, the biological fluid filter can include two or more filter elements. Preferably, the biological fluid filter device includes at least one leukocyte depletion filter element. While it is believed leukocytes are primarily removed by adsorption, they can also be removed by filtration. The pore structure can be selected to remove at least some level of leukocytes, while allowing the passing therethrough of desired components, e.g., at least one of plasma, platelets, and red blood cells. The pore size or removal rating used depends on the composition of the fluid to be treated, and the desired effluent level of the treated fluid.

The filter element can have any desired critical wetting surface tension (CWST, as defined in, for example, U.S. Pat. No. 4,925,572). Typically, the filter element has a CWST of greater than about 53 dynes/cm (about 0.53 erg/mm²; about 53×10⁻⁵ N/cm), more typically greater than about 58 dynes/cm (about 58×10⁻⁵ N/cm), and can have a CWST of about 66 dynes/cm (about 66×10⁻⁵ N/cm) or more. In some embodiments, the element has a CWST of about 75 dynes/cm (about 75×10⁻⁵ N/cm) or more. In some embodiments, the element may have a CWST in the range from about 62 dynes/cm to about 115 dynes/cm (about 62×10⁻⁵ N/cm to about 115×10⁻⁵ N/cm), e.g., in the range of about 80 to about 100 dynes/cm (about 80×10⁻⁵ N/cm to about 100×10⁻⁵ N/cm). In some embodiments, the element has a CWST of about 85 dynes/cm (about 85×10⁻⁵ N/cm), or greater, e.g., in the range from about 90 to about 105 dynes/cm (about 90×10⁻⁵ N/cm to about 105×10⁻⁵ N/cm), or in the range from about 85 dynes/cm to about 98 dynes/cm (about 85×10⁻⁵ N/cm to about 98×10⁻⁵ N/cm).

The surface characteristics of the filter element can be modified (e.g., to affect the CWST, to include a surface charge, e.g., a positive or negative charge, and/or to alter the polarity or hydrophilicity of the surface) by wet or dry oxidation, by coating or depositing a polymer on the surface, or by a grafting reaction. Modifications include, e.g., irradiation, a polar or charged monomer, coating and/or curing the surface with a charged polymer, and carrying out chemical modification to attach functional groups on the surface. Grafting reactions may be activated by exposure to an energy source such as gas plasma, heat, a Van der Graff generator, ultraviolet light, electron beam, or to various other forms of radiation, or by surface etching or deposition using a plasma treatment.

The biological fluid filter in the biological fluid filter device may also include, in addition to at least one filter element, or as a component of at least one filter element, one or more structures having different characteristics and/or functions. For example, the filter can comprise a leukocyte depletion filter element, as well as a prefilter and/or a microaggregate element. The filter can include additional structures such as a mesh or screen, e.g., on the downstream side of the filter element, e.g., for support and/or drainage.

The vent housing and/or the biological fluid filter housing can be fabricated from any suitable impervious material (typically, a rigid material), including any impervious thermoplastic material, which is compatible with the biological fluid being processed. For example, the housing can be fabricated from a metal, such as stainless steel, or from a polymer. In a preferred embodiment, the housing is a polymer, more preferably a transparent or translucent polymer, such as an acrylic, polypropylene, polystyrene, or a polycarbonated resin. Such a housing is easily and economically fabricated, and allows observation of the passage of the biological fluid through the housing.

A variety of materials are suitable for use as vent elements. Suitable elements, including hydrophilic porous and microporous membranes and hydrophobic porous and microporous membranes are disclosed in, for example, U.S. Pat. Nos. 5,126,054 and 5,451,321. The hydrophilic and hydrophobic membranes can have any suitable pore size. Typically, the hydrophilic and/or the hydrophobic membrane has a pore size (preferably, a pore rating) of about 3 micrometers or less, preferably, about 1 micrometers or less, and more preferably, about 0.65 micrometers or less. While a portion of liquid could pass through a porous membrane, e.g., a hydrophilic porous membrane, the operating conditions for using the apparatus and the pore size or pore rating (and, in some embodiments, the biological fluid processed, e.g., a cell-containing fluid) are such that, as is known by one of skill in the art, biological fluid does not pass through the vent into the first container.

A variety of biological fluid filter devices, biological fluid filter elements, conduits, containers, and flow control devices, including those that are commercially available, are suitable for use in accordance with the invention.

### EXAMPLE

This example shows blood can be filtered while maintaining a closed biological fluid processing system, to provide leukocyte-depleted blood in an effluent bag, while reducing the volume of air being passed into the effluent bag, and this can be carried out without a labor intensive effort. The example additionally shows that air can be displaced in the system and directed into the leukocyte filter housing to allow blood that would typically be held up in the filter to be drained and recovered in the effluent bag.

A closed commercially available blood processing system is obtained, comprising a blood collection bag, and a satellite bag, with a leukocyte filter device (connected by conduits) interposed between the collection and satellite (effluent) bag. The blood collection bag contains a unit of whole blood.

An apparatus comprising a fluid processing loop as shown in FIG. 1 is obtained, and connected to a bag containing a unit of whole blood via sterile docking. The loop is produced using commercially available plasticized bags and conduits, e.g., as utilized in the commercially available system described above. The same model leukocyte filter device is used in both the commercially available system and the apparatus. The vent (including the vent element, including a hydrophilic microporous membrane having a pore rating of 0.2 microns and a hydrophobic microporous membrane having a pore rating of 0.65 micrometers) is produced in accordance with U.S. Pat. No. 5,451,321. The check valve is a commercially available normally closed duckbill valve.

The distance between the first container 101 (the collection bag) and the second container 102 (the effluent bag) in the apparatus is the same as the distance between the collection and effluent bags in the commercially available system. The length of conduit 31 in the apparatus is the same as the length of the conduit between the collection bag and the inlet of the filter in the commercially available system, and the combined lengths of conduits 31′ and 33 is the same as the length of the conduit between the filter and the effluent bag in the commercially available system.

The commercially available system is operated in accordance with the manufacturer's instructions, and after filtration is completed, the effluent bag contains about 60 ml of air.

Using FIG. 1 for reference, transfer leg closures 1, 2, and 3 are initially closed, and the check valve in the conduit 32 communicating with transfer leg closure 2 is a normally closed duckbill type valve. While transfer leg closure 3 remains closed, transfer leg closure 1 is opened first, and transfer leg closure 2 is opened next. Whole blood passes from the port 101B of the collection bag 101 through the conduit 31. The blood displaces gas through the conduit, and the gas (followed by the blood) passes into the leukocyte filter device 10 through the filter housing inlet 11, the leukocyte depletion filter medium, the biological fluid housing outlet 12, and through conduit 31′ into the first inlet 21 of the vent housing. Due to the force created by the biological fluid column, gas passes along the second fluid flow path from the first inlet 21 through the vent element 25 (passing through the hydrophilic membrane and then the hydrophobic membrane) through the second outlet 23, conduit 32, check valve 40, and port 101C into the collection bag 101. The leukocyte-depleted blood passes through the first inlet 21 and contacts the hydrophilic medium, but does not pass through the vent element 25 into the collection bag. Once the blood sufficiently contacts the hydrophilic medium, the vent element 25 seals. Air stops passing through the conduit 32 and port 101C into the collection bag 101. Transfer leg closure 3 is then opened, and filtered blood passes through the first outlet 22, conduit 33 and port 102A into the effluent bag 102. After transfer leg closure 3 is opened, and after the collection bag 101 is essentially drained of blood, air passes from the collection bag through port 101B and conduit 31 and through the leukocyte filter housing inlet 11 into the upstream portion of the leukocyte filter housing, draining blood from the upstream portion of the housing (the portion upstream of the filter medium) and through conduits 31′ and 33 into the effluent bag.

In contrast with that of the commercially available system, the effluent bag contains about 15 ml of air, a reduction of about 76%. Moreover, channeling displaced air into the upstream chamber of the filter housing allows an additional 5-8 ml of leukocyte-depleted blood to be recovered in the effluent bag. The reduction of air in the effluent bag, and the recovery of blood from the upstream chamber of the filter housing are accomplished without compressing the effluent bag to expel the air from the bag.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An apparatus for processing gas and a biological fluid contained in a first container comprising at least two fluid flow ports comprising:
a second container for containing a processed biological fluid; and,
a fluid processing loop comprising a biological fluid filter device comprising a biological fluid porous filter element and a biological fluid filter housing, the biological fluid porous filter element being disposed in the filter housing, and a vent comprising a vent element comprising a hydrophilic porous membrane, and a vent housing having a first inlet, a first outlet, and a second outlet, the vent housing defining a first fluid flow path between the first inlet and the first outlet, and defining a second fluid flow path between the first inlet and the second outlet, the vent housing containing the vent element, wherein the vent element is disposed between the first inlet and the second outlet across the second fluid flow path; wherein the fluid processing loop has first and second ends suitable for providing fluid communication with a first and a second fluid flow port of the first container, and the fluid processing loop has a third end in fluid communication with a port of the second container for containing the processed biological fluid;
wherein the fluid processing loop is arranged to allow gas to pass from the first container and along the second fluid flow path through the vent element and into the first container, without allowing biological fluid to pass through the vent into the first container, and to allow biological fluid to pass through the biological fluid filter and along the first fluid flow path into the second container, in a closed system.

2. An apparatus for processing gas and a biological fluid contained in a first container comprising at least two fluid flow ports comprising:
a second container for containing a processed biological fluid; and,
a fluid processing loop comprising a biological fluid filter device comprising a biological fluid porous filter element and a biological fluid filter housing having a first inlet, a first outlet, and a second outlet, and defining a first fluid flow path between the first inlet and the first outlet, and defining a second fluid flow path between the first inlet and the second outlet, wherein the biological fluid porous filter element is disposed in the biological fluid filter housing across the first fluid flow path, the device further comprising a vent comprising a vent element comprising a hydrophilic porous membrane, the vent element being disposed in the biological fluid filter housing across the second fluid flow path;
wherein the fluid processing loop has first and second ends suitable for providing fluid communication with a first and a second fluid flow port of the first container, and the fluid processing loop has a third end in fluid communication with a port of the second container for containing the processed biological fluid;
wherein the fluid processing loop is arranged to allow gas to pass from the first container and along the second fluid flow path through the vent element and into the first container, without allowing biological fluid to pass through the vent into the first container, and to allow biological fluid to pass through the biological fluid filter and along the first fluid flow path into the second container, in a closed system.

3. The apparatus of claim 1, wherein the vent element further comprises a hydrophobic porous membrane.

4. The apparatus of claim 1, wherein the fluid processing loop comprises a first conduit communicating with the first fluid flow port of the container, a second conduit communicating with the second fluid flow port of the first container, and a third conduit communicating the port of the second container for containing a processed biological fluid.

5. The apparatus of claim 4, wherein the second conduit is interposed between, and in fluid communication with, the second fluid flow port of the first container and the second outlet of the vent housing.

6. The apparatus of claim 1, further comprising a check valve attached to the second conduit.

7. The apparatus of claim 1, wherein the vent element comprises at least one microporous membrane.

8. The apparatus of claim 1, wherein the vent element comprises a hydrophobic microporous membrane and a hydrophilic microporous membrane.

9. A closed biological fluid processing system comprising:
an apparatus for processing gas and a biological fluid comprising:
a first container for containing a biological fluid, the container having at least first and second fluid flow ports;
a second container for containing a processed biological fluid; and,
a fluid processing loop comprising a biological fluid filter device comprising a biological fluid porous filter element and a biological fluid filter housing, the biological fluid porous filter element being disposed in the filter housing, and a vent comprising a vent element comprising a hydrophilic porous membrane, and a vent housing having a first inlet, a first outlet, and a second outlet, the vent housing defining a first fluid flow path between the first inlet and the first outlet, and defining a second fluid flow path between the first inlet and the second outlet, the vent housing containing the vent element, wherein the vent element is disposed between the first inlet and the second outlet across the second fluid flow path;
wherein the fluid processing loop, has first and second ends suitable for providing fluid communication with a first and a second fluid flow port of the first container, and the fluid processing loop has a third end in fluid communication with a port of the second container for containing the processed biological fluid,
wherein the fluid processing loop is arranged to allow gas to pass from the first container and along the second fluid flow path through the vent element and into the first container, without allowing biological fluid to pass through the vent into the first container, and to allow biological fluid to pass through the biological fluid filter and along the first fluid flow path into the second container, in a closed system; and,
wherein the first and second ends of the fluid processing loop are in fluid communication with the first and second fluid flow ports of the first container.

10. A method for processing biological fluid comprising:
passing gas and a biological fluid from a first container having at least two fluid flow ports into a fluid processing loop comprising a biological fluid filter device comprising a biological fluid porous filter element and a housing having the biological fluid porous filter element disposed in the housing; and a vent comprising a vent element comprising a hydrophilic porous membrane, and a vent housing having a first inlet, a first outlet, and a second outlet, and defining a first fluid flow path between the first inlet and the first outlet, and a second fluid flow path between the first inlet and the second outlet, the vent housing containing the vent element disposed between the first inlet and the second outlet across the second fluid flow path;
passing gas from the first container and along the second fluid flow path through the vent element and into the first container, without allowing biological fluid to pass through the vent into the first container; and,
passing biological fluid through the biological fluid filter and along the first fluid flow path into a second container; while maintaining a closed system.

11. A method for processing biological fluid comprising:
passing gas and a biological fluid from a first container having at least two fluid flow ports into a fluid processing loop comprising a biological fluid filter device comprising a biological fluid porous filter element and a housing having a first inlet, a first outlet, and a second outlet, and defining a first fluid flow path between the first inlet and the first outlet, and defining a second fluid flow path between the first inlet and the second outlet, the biological fluid porous filter element being in the housing across the first fluid flow path, the device further comprising a vent comprising a vent element comprising a hydrophilic porous membrane, the vent element being in the housing across the second fluid flow path;
passing gas from the first container and along the second fluid flow path through the vent element and into the first container, without allowing biological fluid to pass through the vent into the first container; and,
passing biological fluid through the biological fluid filter and along the first fluid flow path into a second container; while maintaining a closed system.

12. The method of claim 10, wherein passing gas from the first container and along the second fluid flow path through the vent element and into the first container comprises passing gas through a hydrophilic porous membrane and a hydrophobic porous membrane until biological fluid wets the hydrophilic membrane.

13. The method of claim 10, further comprising, after passing gas into the first container, passing gas from the first container into the biological fluid filter housing, and passing biological fluid from the biological fluid filter housing, while maintaining a closed system.
